(19) United States
(12) Patent Application Publication
(10) Pub. No.: US 2023/0381976 A1
(43) Pub. Date: Nov. 30, 2023

(54) HAND, HAND SYSTEM, AND CONTROL METHOD THEREFOR

(71) Applicant: Fanuc Corporation, Minamitsuru-gun, Yamanashi (JP)

(72) Inventor: Atsushi Kimura, Minamitsuru-gun, Yamanashi (JP)

(73) Assignee: Fanuc Corporation, Minamitsuru-gun, Yamanashi (JP)

(21) Appl. No.: 18/032,402

(22) PCT Filed: Oct. 25, 2021
(86) PCT No.: PCT/JP2021/039333

§ 371 Date: Apr. 18, 2023

(30) Foreign Application Priority Data
Oct. 30, 2020 (JP) 2020-182802

(51) Int. Cl. B25J 15/08; B25J 15/00

(52) U.S. Cl. CPC B25J 15/08; B25J 15/0004

(57) ABSTRACT

A hand includes a hand part for removing a workpiece; a workpiece holding part that presses the removed workpiece at a prescribed location so as to hold the same; and a base part that supports the hand part and the workpiece holding part.

### CROSS REFERENCE TO RELATED APPLICATIONS

This is the U.S. National Phase application of PCT/JP2021/039333, filed Oct. 25, 2021, which claims priority to Japanese Patent Application No. 2020-182802, filed Oct. 30, 2020, the disclosures of these applications being incorporated herein by reference in their entireties for all purposes.

### FIELD OF THE INVENTION

The present invention relates to a hand technique, and in particular, to a hand and a hand system capable of picking and fixing a workpiece and a control method therefor.

### BACKGROUND OF THE INVENTION

In buildings, a structure constructed by a combination of steel members such as shaped steel (column steel, H-shaped steel, I-shaped steel, etc.) and steel bars is called a steel frame structure (S structure). As a method for connecting each member of the steel frame structure, fastening and welding are used. In principle, welding is used when joining in advance at a factory, etc., and fastening is used when joining on site, but large-scale structures are often joined by welding without using screws such as bolts. Joining of steel frame members by welding is performed by butting and temporarily fixing by a clamp (a screw clamp) or a jig, and by welding a seam joint between the members.

In welding of steel frame structures, in addition to base materials such as main columns and beams, auxiliary materials such as backing metals and end tabs are sometimes integrally welded. The auxiliary material, such as the backing metal and the end tab serves to reinforce portions at which defects are likely to occur, such as starting and ending edges of the welded steel structure, an intersection of seams, a butting portion, etc. Also, when the backing metal is used, only one side needs to be welded, so that a number of man-hours is reduced, workability is improved, and economic efficiency is superior, compared to back-chipping which requires double-sided welding.

Joining of steel frame materials by welding is performed by manual welding, semi-automatic welding, or automatic welding, etc. since the manual welding and the semi-automatic welding require the use of techniques and equipment for welding or delivery, etc., it is necessary to secure engineers. In addition, adverse environmental conditions caused by welding such as high temperature, arc light, dust, spatter, etc., and an operation at high or low places, and an operation facing upward place impose a heavy physical burden on an operator. Therefore, automatic welding using a welding machine such as a welding robot is often introduced. Even in the automatic welding, the flow of joining does not change significantly, and it is necessary to temporarily fix the members together before welding. In order to butt and temporarily fix main base materials such as columns or beams, automation is achieved by using a large-sized jig equipped with an electric actuator or a hydraulic actuator.

However, when temporarily fixing the auxiliary material such as the backing metal and the end tab which are smaller than the base material such as the column or the beam, especially in a limited space such as a corner and or a gap, it is often difficult to use the jig for the base material also for temporary fixing of the auxiliary material, since the size difference between the base material and the auxiliary material is large. Therefore, temporary fitting welding is sometimes performed manually before the automatic welding process, and automation of the entire welding process may have not yet been achieved. Thus, there is demand for a technique for fixing a workpiece at a predetermined position, even in a limited space such as a corner or a gap.

Incidentally, as a pick-and-place hand for an industrial robot, etc., various types of hands such as a multi-fingered gripping hand, a magnetic attraction hand, a vacuum suction hand, and a Bernoulli hand are known. These hands take out a workpiece, and deliver the workpiece after it is transported to a predetermined position. However, the conventional hand does not have the function of fixing the workpiece in close contact with the predetermined position. Well-known techniques related to the present application include the following.

Patent Literature 1 discloses a welding backing jig. The welding backing jig is configured by a cylinder rotatably provided on a back side of a welding member, and a backing metal pressing pedestal pivotally attached to the tip of the cylinder. One side of the tip of the cylinder swingably holds the backing metal, and the other side of the tip of the cylinder has a latching end which abuts the welding member.

Patent Literature 2 discloses a backing metal mechanism. The backing metal mechanism has a parallel link mechanism. One end of the parallel link is rotatably attached to a clamp support, etc., and the other end of the parallel link rotatably holds a supporting member of the backing metal.

Patent Literature 3 discloses a backing metal fixing device. The backing metal fixing device includes upper and lower backing metal fixing metals, upper and lower screw rods erected from the backing metal fixing metals and having opposite threads, and a coupler screwed over the upper and lower screw rods.

Patent Literature 4 discloses a robot hand. The robot hand is detachably attached to a front end of a wrist of an articulated robot. The robot hand has a fixed gripper and a movable gripper. The list is rotatable.

### PATENT LITERATURE

[PTL 1] JP 1994(H06)-034890 U
[PTL 2] JP 1984(S59)-001477 U
[PTL 3] JP 1988(H10)-258393 A
[PTL 4] JP 2018-111172 A

### SUMMARY OF THE INVENTION

The purpose of the present invention is to provide a hand technique capable of taking out and fixing a workpiece, in view of the above problems.

One aspect of the present disclosure provides a hand comprising: a hand part configured to take out a workpiece; a workpiece holding part configured to hold the taken out workpiece by pressing the workpiece against a predetermined position; and a base part configured to support the hand part and the workpiece holding part.

Another aspect of the present disclosure provides a hand system comprising: a hand configured to take out a workpiece; and a conveying device, to which the hand is attached, configured to convey the workpiece, wherein the hand comprising: a hand part configured to take out a workpiece; a workpiece holding part configured to hold the taken out workpiece by pressing the workpiece against a predetermined position; and a base part configured to support the hand part and the workpiece holding part, and wherein the conveying device is configured to convey the workpiece taken out by the hand part to the vicinity of the predetermined position.

Further aspect of the present disclosure provides a control method of a hand system, the hand system comprising: a hand configured to take out a workpiece; and a conveying device, to which the hand is attached, configured to convey the workpiece, the control method comprising the steps of: taking out the workpiece by the hand; conveying the taken out workpiece to the vicinity of a predetermined position by the conveying device; and holding the taken out workpiece by pressing it against the predetermined position.

According to the one aspect of the present disclosure, it is possible to provide a hand technique capable of taking out and holding a workpiece. Further, even when the holding position of the workpiece is in a location where it is difficult to work, such as a high place, a low place or a limited space, etc., the taking-out and holding operations of the workpiece can be automated.

### BRIEF DESCRIPTION OF DRAWINGS

FIG. 1 is a schematic configuration view of a hand system of a first embodiment.

FIG. 2 is a perspective view of a hand of the first embodiment.

FIG. 3 is a perspective view of the hand of the first embodiment.

FIG. 4 is a perspective view of the hand for holding a workpiece in one direction.

FIG. 5 is a perspective view of the hand wherein a base part is rotated.

FIG. 6 is a perspective view of the hand for holding the workpiece in one direction.

FIG. 7 is a perspective view of a hand of a second embodiment.

FIG. 8 is a perspective view of the hand wherein a base part is rotated.

FIG. 9 is a perspective view of the hand wherein the base part is further rotated.

FIG. 10 is a perspective view of the hand wherein the base part is further rotated.

FIG. 11 is a perspective view of the hand for holding the workpiece in two directions.

FIG. 12 is a perspective view of the hand for holding the workpiece in two directions.

FIG. 13 is a perspective view of the hand for holding the workpiece in two directions.

FIG. 14 is a perspective view of the hand for holding the workpiece in two directions.

FIG. 15 is a perspective view showing of a flow from when the workpiece is take out to when the workpiece is held.

FIG. 16 is a flowchart showing a control method of the hand system.

FIG. 17 is a perspective view of a hand of a third embodiment.

FIG. 18 is a perspective view of a hand of a third embodiment.

FIG. 19 is a perspective view of the hand wherein the workpiece is held in a depth direction.

FIG. 20 is a perspective view of the hand wherein the workpiece is held in a depth direction.

FIG. 21 is a perspective view of a hand of a fourth embodiment.

FIG. 22 is a perspective view of the hand wherein a base part is rotated.

FIG. 23 is a perspective view of the hand for holding the workpiece in three directions.

FIG. 24 is a perspective view of the hand for holding the workpiece in three directions.

FIG. 25 is a perspective view of the hand for holding the workpiece in three directions.

FIG. 26 is a perspective view of the hand for holding the workpiece in three directions.

### DETAILED DESCRIPTION OF EMBODIMENTS OF THE INVENTION

The embodiments of the present disclosure will be described in detail below, with reference to the attached drawings. In the drawings, identical or similar constituent elements have been assigned the same or similar reference signs. Further, the embodiments described below do not limit the technical scope of the invention described in the claims or the definitions of the terms. In addition, the description “taking out (of) a (the) workpiece” as used herein means picking up the workpiece from a predetermined position such as a stacker. The description “holding (of) a (the) workpiece” as used herein means not only temporary holding of the workpiece but also semi-permanent fixing of the workpiece, such as bonding the workpiece with an adhesive or engaging the workpiece with a snap fit. The term “rotation” used herein includes both normal rotation and reverse rotation. Also, the terms “outside” and “inside” used herein mean outside and inside of the hand, respectively. Thus, the term “outward” means outward and away from the hand, and the term “inward” means inward and toward the hand.

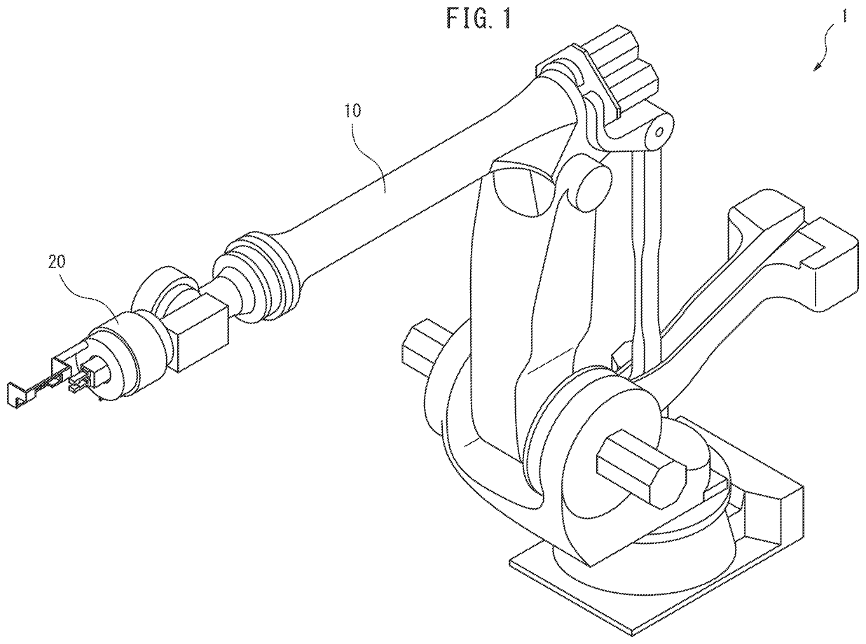

First, a hand system 1 of a first embodiment will be described. FIG. 1 is a schematic configuration view of the hand system 1. The hand system 1 is a system for performing taking out and holding of a workpiece. The hand system 1 has a hand 20 configured to take out a workpiece, and a conveying device 10, to which the hand 20 is attached, configured to convey the workpiece. For example, the conveying device may be an industrial robot such as a vertical multi joint robot. The conveying device 10 has a control part configured to control the robot, for example. The control part has, for example, a programmable logical controller (PLC) incorporating a processor and a semiconductor integrated circuit such as an FPGA (field-programmable gate array) which does not execute a program, etc. The hand 20 is detachably attached to the conveying device 10, for example.

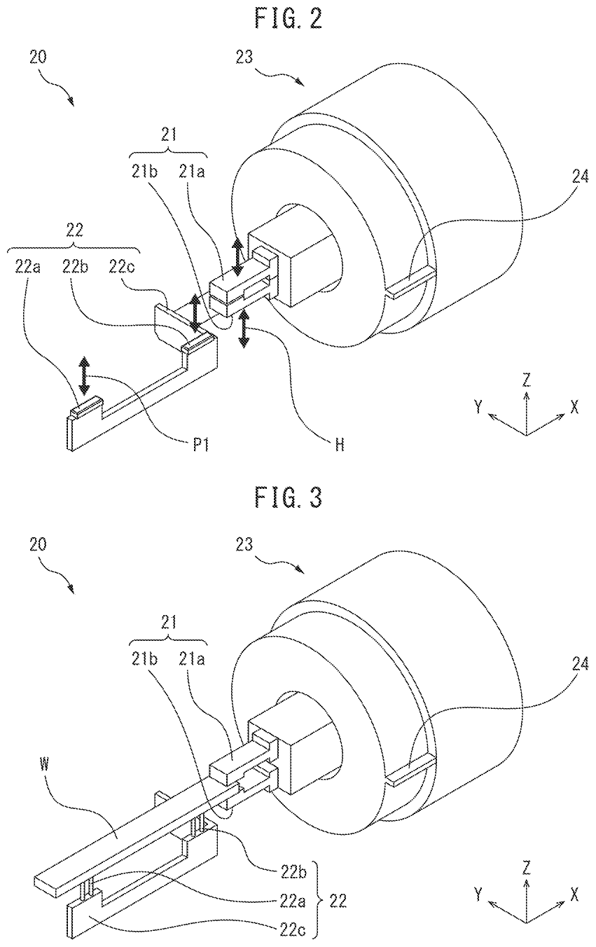

FIGS. 2 and 3 are perspective views of the hand 20 of the first embodiment. The hand 20 is a hand configured to take out the workpiece and hold the workpiece in one direction. For example, the hand 20 has a hand part 21 configured to take out the workpiece; a workpiece holding part 22 configured to hold the workpiece by pressing the workpiece against a predetermined position; and a base part 23 configured to support the hand part 21 and the workpiece holding part 22. The hand part 21 is, for example, a multi-fingered gripping hand such as a gripper, and has a first finger 21a and a second finger 21b. The first finger 21a and the second finger 21b are moved in a hand direction H orthogonal to the axial direction of the hand 20 (e.g., the X-axis direction) to take out and deliver the workpiece. The first finger 21a and the second finger 21b are driven by a drive source (not shown) such as a servomotor, for example.

The workpiece holding part 22 holds the workpiece by pressing it in a first direction P1 orthogonal to the axial direction of the hand 20 (e.g., the X-axis direction). For example, the workpiece holding part 22 includes a plurality of movable members 22a and 22b configured to move forward and backward in the first direction P1, and a supporting member 22c configured to support the movable members 22a and 22b. The movable members 22a and 22b are rod-shaped bodies, for example. The movable members 22a and 22b are driven by a drive source (not shown) such as a servomotor. The supporting member 22c is a bracket fixed to the base part 23, for example.

The base portion 23 is, for example, a cylindrical body. The base part 23 is attached to the conveying device 10. The hand part 21 and the workpiece holding part 22 are supported by the base part 23, and extend outward in the axial direction of the hand 20 from the base part 23. Further, the workpiece holding part 22 extends further outward from the hand 20 than the hand part 21. In other words, the movable members 22a and 22b are arranged outside the hand 20 relative to the hand part 21. This makes it possible to press and hold the workpiece W in the first direction P1 with the work holding part 22 in a state wherein the workpiece W is taken out by the hand part 21.

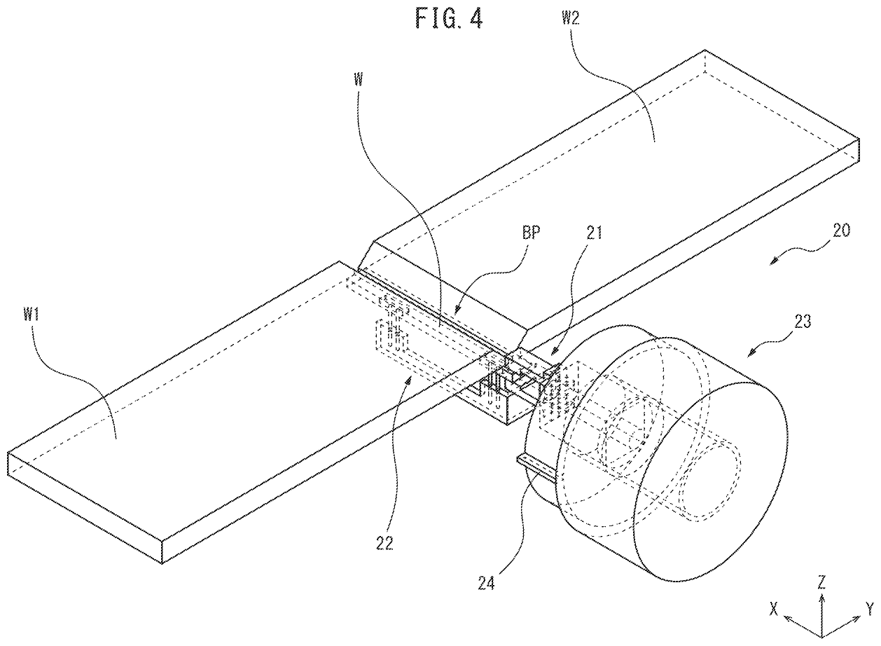

FIG. 4 is a perspective view of the hand 20 configured to hold the workpiece W in one direction (e.g., the back side of a butt part BP). For example, when the ends of a first work material W1 and a second work material W2, which are base materials such as steel plates, should be butted against each other and welded (i.e., when butt welding of the first work material W1 and the second work material W2 should be performed), the hand 20 is useful for holding the workpiece W, which may be a backing metal, by pressing it against the butt part BP. That is, the workpiece W taken out by the hand part 21 is held by pressing the workpiece W against the back side of the butt part BP using the workpiece holding part 22. The workpiece W may be delivered from the hand part 21 while the workpiece W is held by pressing against the back side of the butt part BP. By virtue of this, the workpiece W can be brought into close contact with the back side of the butt part BP. After that, welding is performed from the front side of the butt part BP by another welding machine such as a welding robot.

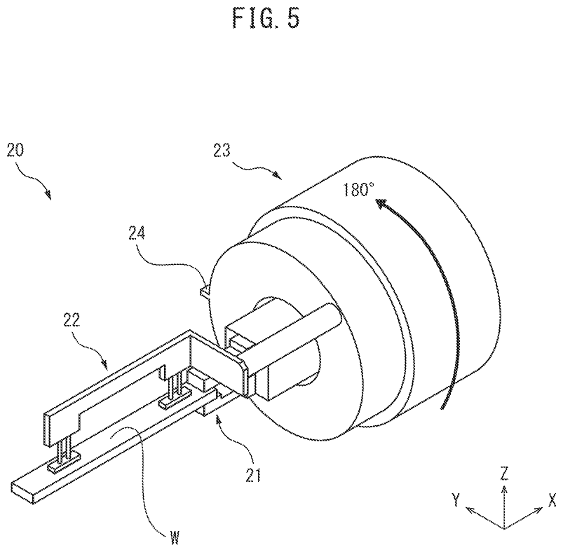

FIG. 5 is a perspective view of the hand 20 with the base part 23 rotated. The base part 23 is attached to the conveying device 10 (see FIG. 1), and is rotated corresponding to the motion of the conveying device 10. The base part 23 rotates the hand 20 as a whole. The hand part 21 and the workpiece holding part 22 are rotated together corresponding to the motion of the base part 23.

The base part 23 may be provided with a rotation angle displaying part 24 configured to display the rotation angle of the hand 20. The rotation angle displaying part 24 may be, for example, a projecting piece which projects from the side peripheral surface of the base part 23. Comparing the rotation angle displaying part 24 shown in FIG. 5 and FIG. 3, it can be understood that the hand 20 shown in FIG. 5 is rotated by 180° about the axis (e.g., about the X-axis) from the rotation angle of the hand 20 shown in FIG. 3. By virtue of this, the pressing direction of the workpiece W by the workpiece holding part 22 can be changed. In addition, the hand 20 can also be rotated by an arbitrary angle instead of 180°.

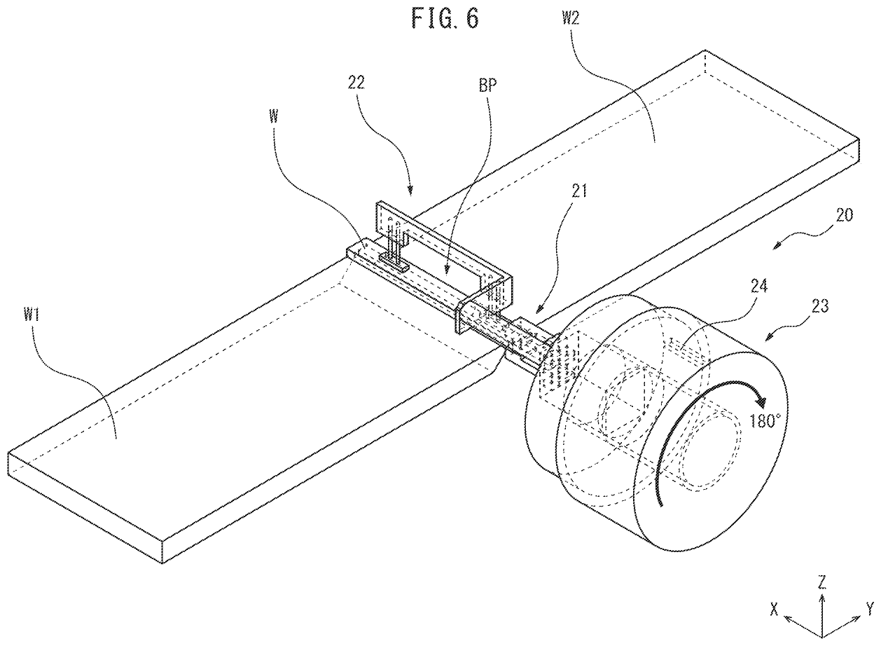

FIG. 6 is a perspective view showing the hand 20 configured to hold the workpiece W in one direction (e.g., the front side of the butt part BP). For example, when the workpiece W should be held by pressing it against the front side of the butt part BP between the first work material W1 and the second work material W2, the base part 23 is rotated so that the rotation angle of the entirety of the hand 20 corresponds to the angle of the front side of the butt part BP. For example, after the workpiece W is taken out from a stacker, etc., by the hand part 21, the entirety of the hand 20 is rotated by 180° about the axis (e.g., about the X-axis) until or after the workpiece W is conveyed to the vicinity of the front side of the butt part BP by the conveying device 10 (see FIG. 1). Subsequently, the taken out workpiece W is held by pressing it against the front side of the butt part BP by the work holding part 22. It is preferable that the workpiece W is delivered from the hand part 21 while the work W is pressed and held against the front side of the butt part BP. By virtue of this, it becomes possible to bring the workpiece W into close contact with the front side of the butt part BP. After that, welding is performed from the back side of the butt part BP by another welding machine such as a welding robot.

According to the hand 20 of the first embodiment, it is possible to take out the workpiece and held the workpiece in one direction. In addition, even if the holding position of the workpiece W (e.g., the front side or the back side of the butt part) is in a location where it is difficult to work, such as a high place, a low place or a limited space, etc., the taking-out and holding operations of the workpiece can be automated.

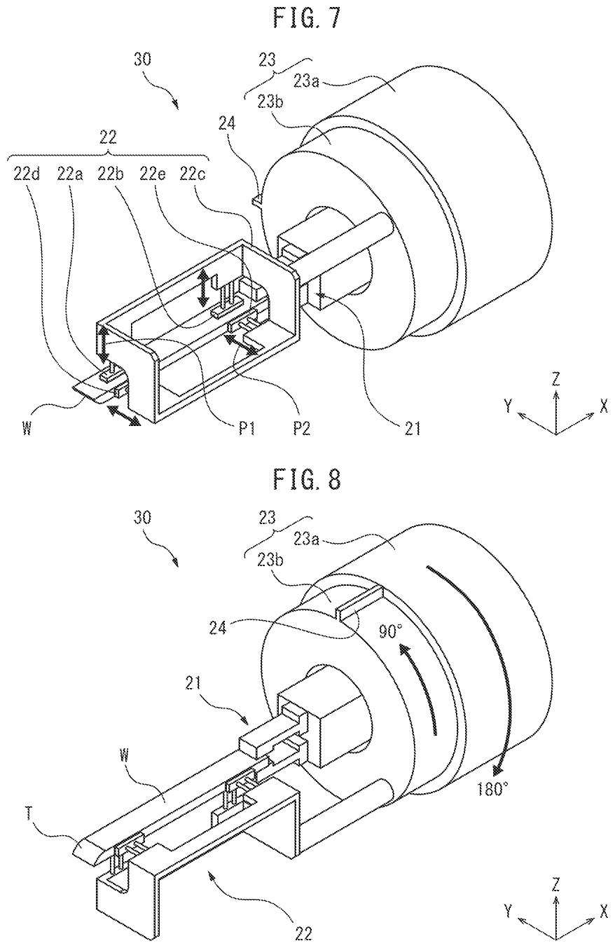

Hereinafter, a hand 30 of a second embodiment will be described. FIG. 7 is a perspective view of a hand 30 of the second embodiment. For ease of understanding, only configurations different from the hand 20 of the first embodiment will be described. The hand 30 is a hand configured to take out the workpiece and hold it in two directions. The workpiece holding part 22 holds the workpiece by pressing it in a first direction P1 orthogonal to the axial direction of the hand 30 (the X-axis direction), and a second direction P2 orthogonal to the first direction P1. For example, the workpiece holding part 22 includes a plurality of movable members 22a and 22b configured to move forward and backward in the first direction P1, and a plurality of movable members 22d and 22e configured to move forward and backward in the second direction P2 orthogonal to the first direction P1. The movable members 22d and 22e are rod-shaped bodies, for example. The movable members 22d and 22e are driven by a drive source (not shown) such as a servomotor.

The movable members 22d and 22e are supported by the supporting member 22c, for example. The supporting member 22c is a bracket fixed to the base part 23, for example. The supporting member 22c may have at least one of a first contact surface FS and a second contact surface SS which can contact a predetermined position of the workpiece W to be pressed. By bringing at least one of the first contact surface FS and the second contact surface SS into contact with the predetermined position such as a corner of workpiece W to be pressed, the workpiece can be stably held.

Also, the movable members 22a, 22b, 22d and 22e are arranged outside the hand 30 relative to the hand part 21. By virtue of this, the workpiece W can be pressed and held by the workpiece holding part 22 in the first direction P1 and the second direction P2 in a state wherein the workpiece W is taken out by the hand part 21.

FIG. 8 is a perspective view of the hand 30 wherein the base part 23 is rotated. The base part 23 may include a hand rotating part 23a configured to rotate the entirety of the hand 30, and a workpiece holding rotating part 23b configured to rotate only the workpiece holding part 22. The hand rotating part 23a is attached to the conveying device 10 as exemplified in FIG. 1, and is rotated corresponding to the motion of the conveying device 10. The hand rotating part 23a is, for example, a cylindrical body. The hand rotating part 23a supports the hand part 21 at its rotation center, for example. The hand part 21 extends from the hand rotating part 23a and toward outside of the hand 30. The hand part 21 rotates by an arbitrary angle about the axis of the hand 30 (e.g., about the X-axis) according to the motion of the hand rotating part 23a. The hand rotating part 23a and the workpiece holding rotating part 23b are coupled by a gear or a bearing, etc., for example.

The workpiece holding rotating part 23b is configured to rotate on the hand rotating part 23a. The workpiece holding rotating part 23b is, for example, a hollow cylindrical body. The workpiece holding rotating part 23b supports the work holding part 22, for example, at its cylindrical bottom surface. The workpiece holding part 22 extends from the workpiece holding rotating part 23b and toward outside of the hand 30. The workpiece holding part 22 rotates by an arbitrary angle about the axis of the hand 30 (e.g., about the X-axis) according to the motion of the workpiece holding rotating part 23b. The hand rotating part 23a and the workpiece holding rotating part 23b are driven by a drive source (not shown) such as a servomotor.

For example, the hand rotating part 23a shown in FIG. 8 rotates by 180° about the axis (e.g., about the X-axis) from the rotation angle of the hand rotating part 23a shown in FIG. 7. By virtue of this, the workpiece W taken out by the hand part 21 can be turned upside down. The workpiece W has a chamfered portion T which is obliquely chamfered at its front end. For example, when comparing the workpieces W in FIGS. 8 and 7, it can be understood that the chamfered portion T shown in FIG. 8 faces in the opposite direction in the Z-axis direction compared to the chamfered portion T shown in FIG. 7.

The rotation angle displaying part 24 displays the rotation angle of the workpiece holding part 22 The rotation angle displaying part 24 may be, for example, a projecting piece which projects from the outer peripheral surface of the workpiece holding rotating part 23b. Comparing the rotation angle displaying part 24 shown in FIG. 8 and FIG. 7, it can be understood that the workpiece holding rotating part 23b shown in FIG. 8 is rotated by 90° about the axis (e.g., about the X-axis) from the rotation angle of the workpiece holding rotating part 23b shown in FIG. 7. By virtue of this, the pressing direction of the workpiece W by the workpiece holding part 22 can be changed.

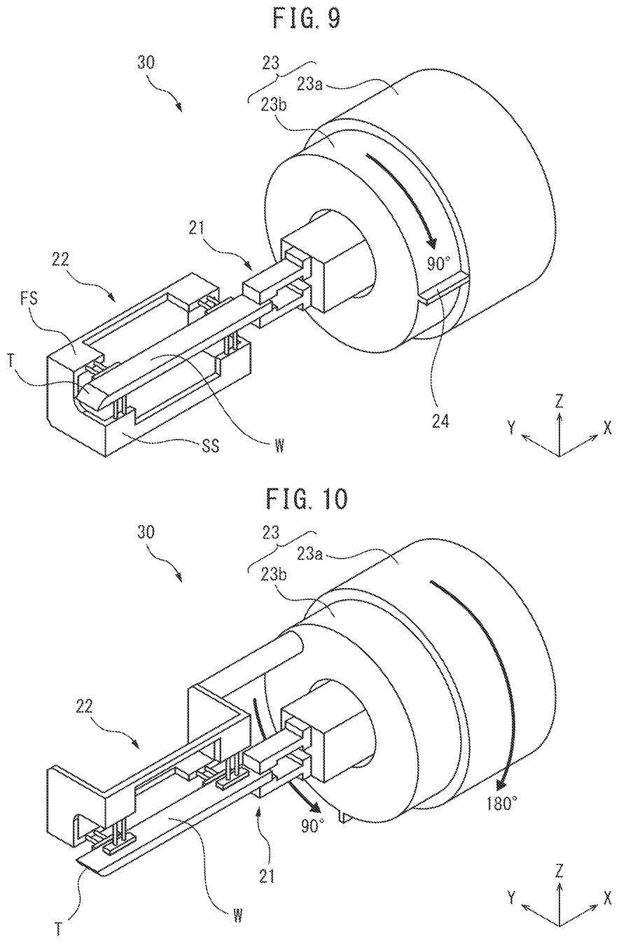

FIG. 9 is a perspective view of the hand 30 wherein the base part 23 is further rotated. The hand rotating part 23a shown in FIG. 9 does not rotate from the rotation angle of the hand rotating part 23a shown in FIG. 8. On the other hand, comparing the rotation angle displaying part 24 shown in FIG. 9 and FIG. 8, it can be understood that the workpiece holding rotating part 23b shown in FIG. 9 is rotated by 90° about the axis (e.g., about the X-axis) from the rotation angle of the workpiece holding rotating part 23b shown in FIG. 8. By virtue of this, only the pressing direction of the workpiece W by the workpiece holding part 22 can be changed, without turning over the workpiece W taken out by the hand part 21.

FIG. 10 is a perspective view of the hand 30 wherein the base part 23 is further rotated. The hand rotating part 23a shown in FIG. 10 is rotated by 180° about the axis (e.g., about the X-axis) from the rotation angle of the hand rotating part 23a shown in FIG. 9. On the other hand, comparing the rotation angle displaying part 24 shown in FIG. 10 and FIG. 9, it can be understood that the workpiece holding rotating part 23b shown in FIG. 10 is further rotated by 90° about the axis (e.g., about the X-axis) from the rotation angle of the workpiece holding rotating part 23b shown in FIG. 9. By virtue of this, the workpiece W taken out by the hand part 21 can be turned upside down, and the pressing direction of the workpiece W by the workpiece holding part 22 can also be changed.

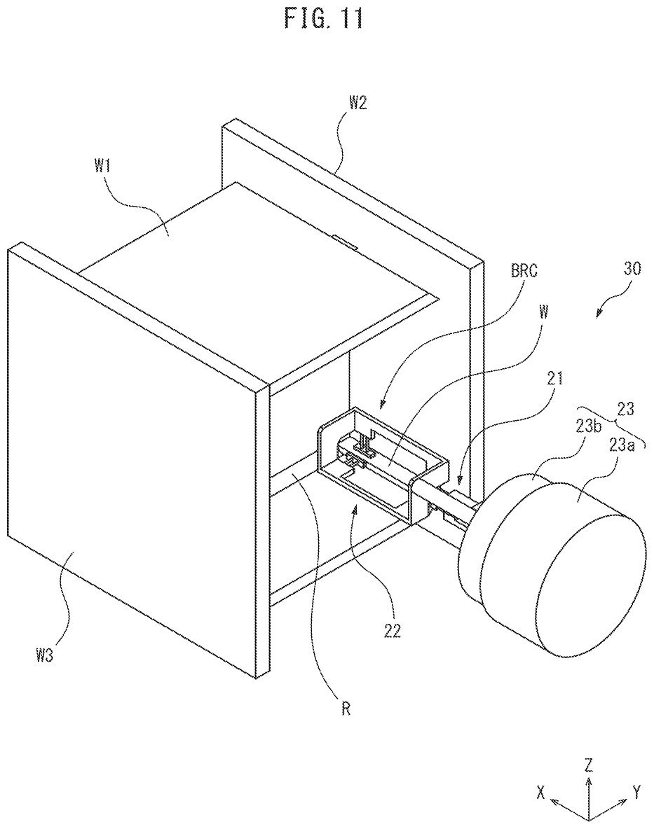

FIGS. 11 to 14 are perspective views of the hand 30 configured to hold the workpiece W in two directions (e.g., at a corner). For example, when welding a second work material W2 and a third work material W3, which are two steel plates, to both sides of a first work material W1, which is an H-shaped steel, the hand 30 is useful for pressing and holding the workpiece W, which may be a backing metal, at a corner formed between the first work material W1 and the second work material W2, or between the first work material W1 and the third work material W3. It should be noted that the first work material W1 has a curved portion R at the base of the column portion, and the chamfered portion T of the workpiece W (see FIG. 8) has a curved shape following the curved portion R of the first work material W1.

The hand 30 shown in FIG. 11 holds the workpiece W by pressing it against a bottom right corner BRC formed between the first work material W1 and the second work material W2. In other words, the workpiece holding part 22 holds the workpiece W by pressing it in two directions (e.g., the X-axis direction and the Z-axis direction). The hand 30 can hold the workpiece W even at a corner in such a limited space.

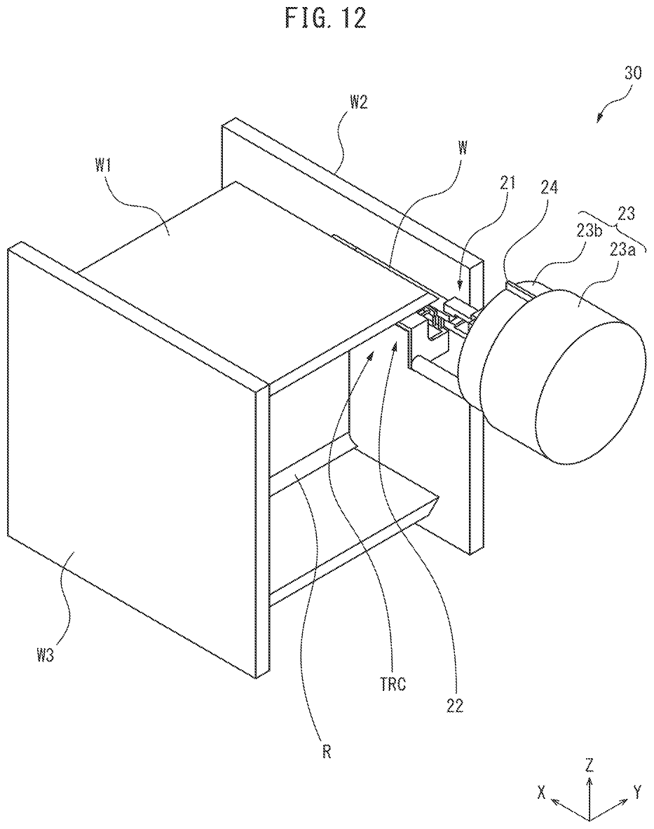

The hand 30 shown in FIG. 12 holds the workpiece W by pressing it against a top right corner TRC formed between the first work material W1 and the second work material W2. Comparing the hand 30 shown in FIG. 12 and FIG. 11, it can be understood that the hand rotating part 23a turns over the workpiece W by rotating by 180° about the axis (e.g., about the X-axis), while the workpiece holding rotating part 23b changes the pressing direction of the workpiece W by rotating by 90° about the axis (e.g., about the X-axis).

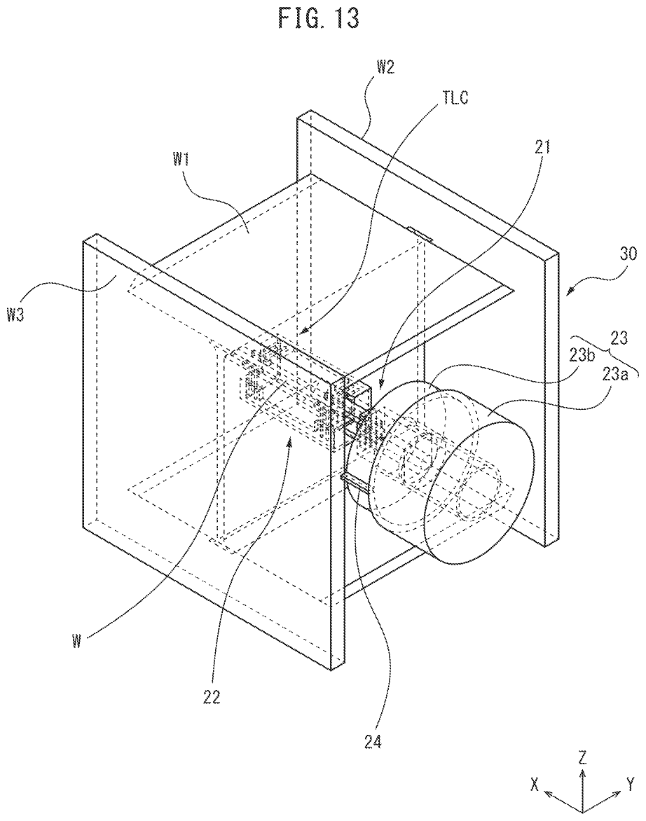

The hand 30 shown in FIG. 13 holds the workpiece W by pressing it against a top left corner TLC formed between the first work material W1 and the third work material W3. Comparing the hand 30 shown in FIG. 13 and FIG. 12, it can be understood that the workpiece W is not turned upside down, since the hand rotating part 23a does not rotate, while the workpiece holding rotating part 23b changes only the pressing direction of the workpiece W by rotating by 90° about the axis (e.g., about the X-axis).

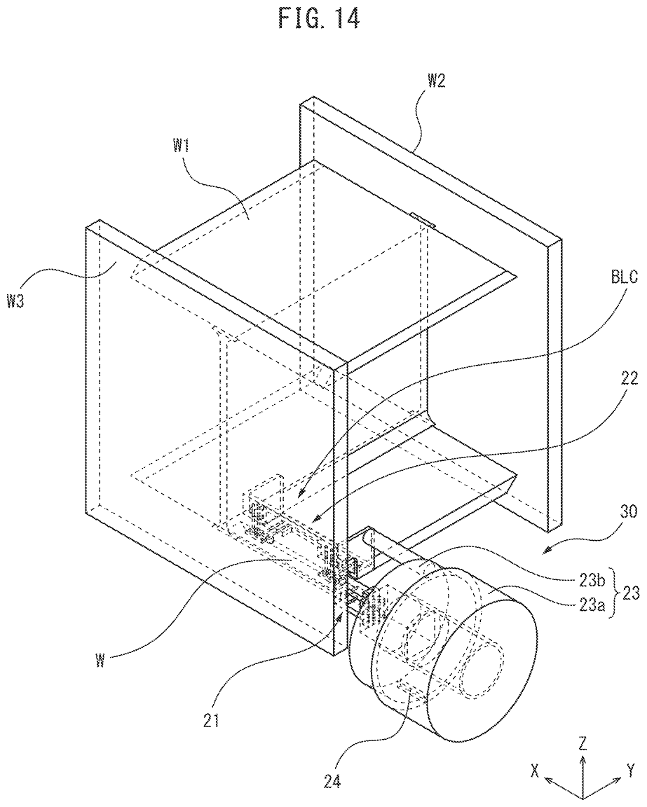

The hand 30 shown in FIG. 14 holds the workpiece W by pressing it against a bottom left corner BLC formed between the first work material W1 and the third work material W3. Comparing the hand 30 shown in FIG. 14 and FIG. 13, it can be understood that the hand rotating part 23a turns over the workpiece W by rotating by 180° about the axis (e.g., about the X-axis), while the workpiece holding rotating part 23b changes the pressing direction of the workpiece W by rotating by 90° about the axis (e.g., about the X-axis).

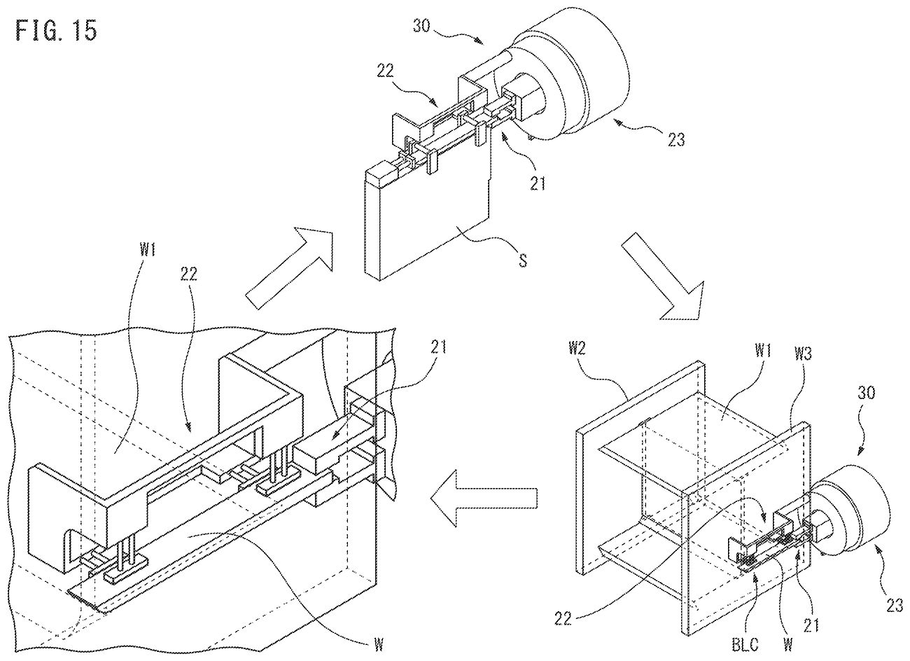

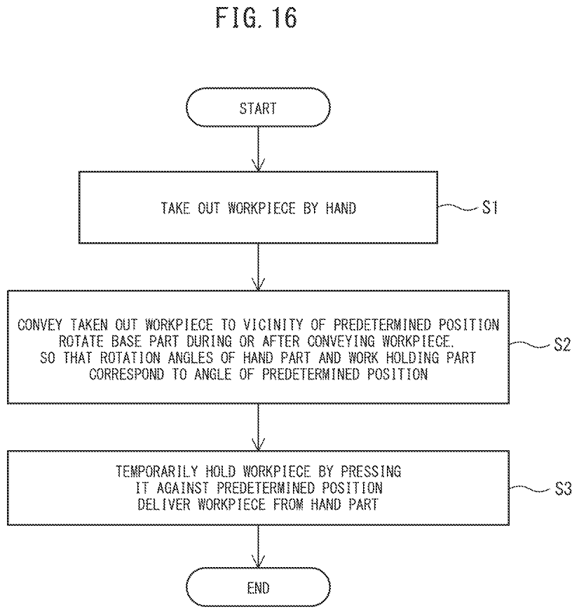

Hereinafter, in a case where the workpiece W is to be held at a corner, a process flow from taking out the workpiece to holding the workpiece will be explained. FIG. 15 is a perspective view showing the flow from taking out the workpiece to holding the workpiece, and FIG. 16 is a flowchart showing a control method of the hand system 1. It should be noted that a program executing this flowchart is executed, for example, by a processor within the control part of the conveying device 10.

First, the workpiece W, which may be a backing metal, is taken out from the stacker S by the hand part 21 (step S1). Before the workpiece W is taken out from the stacker S, the movable member of the workpiece holding part 22 may be retracted so that the movable member does not interfere with the stacker S. Next, the taken out workpiece W is conveyed by the conveying device (see FIG. 1) to the vicinity of the bottom left corner BLC (step S2), for example. After the workpiece W is taken out from the stacker S, while or after the workpiece W is conveyed to the vicinity of the bottom left corner BLC, at least one of the hand rotating part 23a and the workpiece holding rotating part 23b (the base part 23) may be rotated so that the rotation angles of the hand part 21 and the workpiece holding part 22 correspond to the angle of the bottom left corner portion BLC. Subsequently, the workpiece W is held by pressing it against the bottom left corner BLC by the workpiece holding part 22 (step S3). The workpiece W may be delivered from the hand part 21 while the workpiece W is pressed and held against the bottom left corner BLC. By virtue of this, it is possible to bring the workpiece W into close contact with the bottom left corner BLC. After that, another welding machine such as a welding robot performs welding from the back side of the bottom left corner BLC.

According to the hand 30 of the second embodiment, it is possible to take out the workpiece and hold the workpiece in the two directions. Further, even if the holding position of the workpiece W (e.g., a corner) is in a location where it is difficult to work, such as a high place, a low place or a limited space, etc., the taking-out and holding operations of the workpiece can be automated.

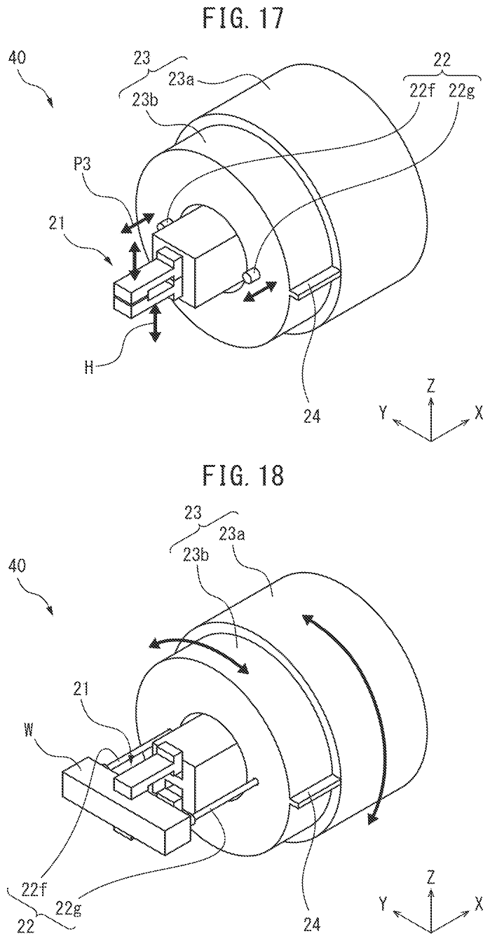

Hereinafter, a hand 40 of a third embodiment will be described. FIGS. 17 and 18 are perspective views of a hand 40 of the third embodiment. For ease of understanding, only configurations different from the hand 30 of the second embodiment will be described. The hand 40 is a hand configured to take out the workpiece and hold it in one direction. The hand 40 differs from the hand 30 of the second embodiment in that the hand 40 holds the workpiece in the axial direction of the hand 40 (e.g., the X-axis direction), i.e., in the depth direction. The workpiece holding part 22 holds the workpiece W by pressing it in the third direction P3 which is the same as the axial direction of the hand 40. The workpiece holding part 22 includes a plurality of movable members 22f and 22g configured to move forward and backward in the third direction P3.

The movable members 22f and 22g are rod-shaped bodies, for example. The movable members 22f and 22g are supported by the base part 23. The movable members 22f and 22g are configured to move forward toward the outside of the hand 40 relative to the hand part 21, and move backward toward the inside of the hand 40 relative to the hand part 21. The movable members 22f and 22g are positioned around the hand 21, for example. By virtue of this, while the workpiece W is taken out by the hand part 21, the workpiece W can be held by pressing it in the third direction P3, i.e., the depth direction, by the movable members 22f and 22g. The movable members 22f and 22g are driven by a drive source (not shown) such as a servomotor.

Similarly to the hand 30 of the second embodiment, the base part 23 has the hand rotating part 23a configured to rotate the entirety of the hand 40, and the workpiece holding rotating part 23b configured to rotate only the workpiece holding part 22. The hand part 21 rotates by an arbitrary angle about the axis of the hand 40 (e.g., about the X-axis) according to the motion of the hand rotating part 23a. The hand rotating part 23a and the workpiece holding rotating part 23b are coupled by a gear or a bearing, etc., for example.

The workpiece holding rotating part 23b is configured to rotate on the hand rotating part 23a. The workpiece holding part 22 rotates by an arbitrary angle about the axis of the hand 40 (e.g., about the X-axis) according to the motion of the workpiece holding rotating part 23b. The hand rotating part 23a and the workpiece holding rotating part 23b are driven by a drive source (not shown) such as a servomotor.

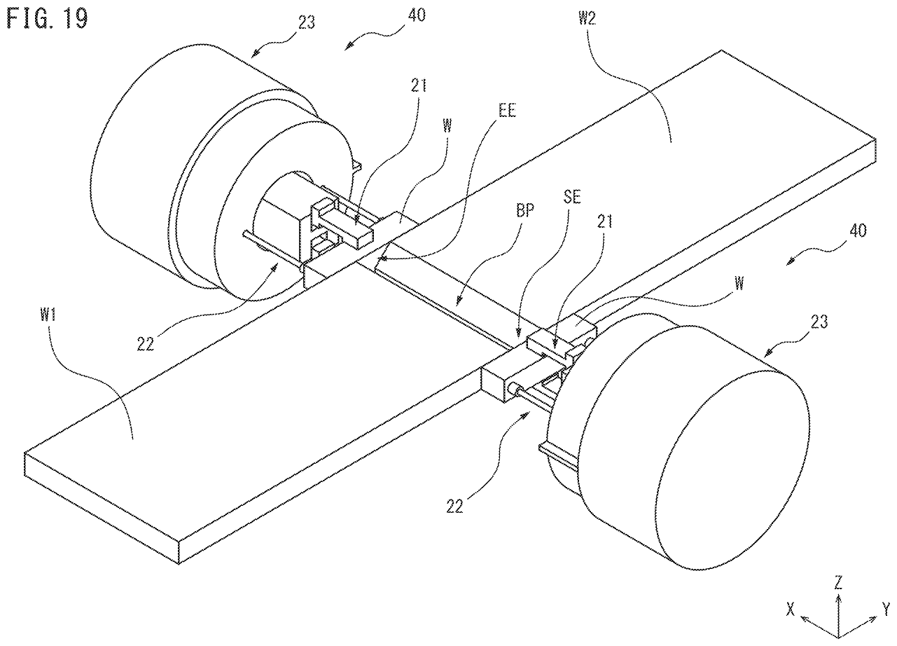

FIG. 19 is a perspective view showing the hands 40 configured to hold the workpieces W in the depth direction (e.g., at the starting edge SE and the ending edge EE of the butt part BP). The hands are useful for holding two workpieces W, which may be end tabs, by pressing them against the starting edge SE and the ending edge EE of the butt part BP, respectively. In other words, the workpieces W taken out by the hand part 21 are held by pressing them against the starting edge SE and the ending edge EE of the butt part BP using the two hands 40. The workpieces W may be delivered from the hand part 21 while the workpieces W are held by pressing against the starting edge SE and the ending edge EE of the butt part BP. By virtue of this, the workpieces W can be brought into close contact with the starting edge SE and the ending edge EE, respectively, and further, the hand 21 can be prevented from interfering with a subsequent welding process. After that, welding is performed from the starting edge SE and the ending edge EE of the butt part BP by another welding machine such as a welding robot.

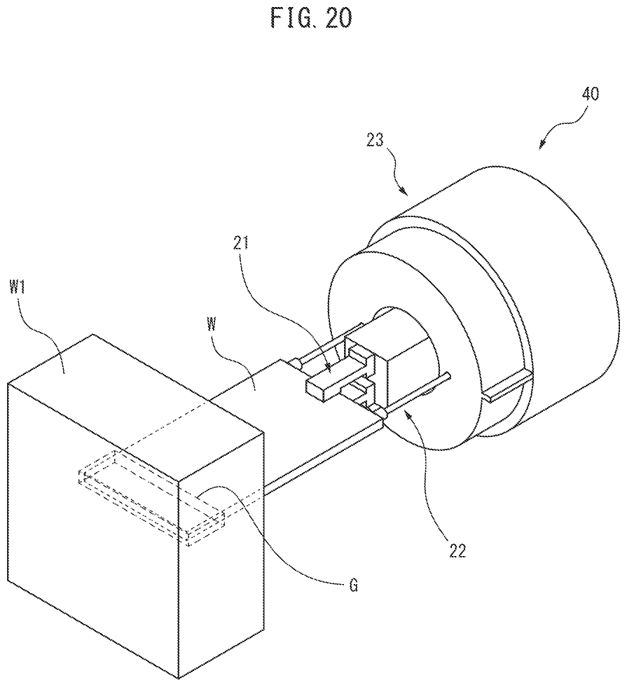

FIG. 20 is a perspective view showing the hand 40 configured to hold the workpiece W in the depth direction (a gap G). The hand 40 is useful for holding the workpiece W, which may be a plate-like body, by inserting it into the gap G of a member W1. That is, the workpiece W taken out by the hand part 21 is conveyed to an entrance of the gap G by the conveying device 10 (see FIG. 1), and then the workpiece W is held by inserting it into the gap G using the workpiece holding part 22. The workpiece W may be delivered from the hand part 21 while the workpiece W is held by inserting into the gap G. By virtue of this, it is not necessary to move the conveying device 10 while the workpieces W is inserted and held. If the workpiece W cannot be inserted and held by the workpiece holding part 22, the workpiece W may be repositioned at the entrance of the gap G by the conveying device 10. After that, welding is performed at the entrance of the gap G by another welding machine such as a welding robot.

According to the hand 40 of the third embodiment, it is possible to take out the workpiece and hold the workpiece in the axial direction (i.e., the depth direction). In addition, even if the holding position of the workpiece W (such as the starting and ending edges and the gap of the butt part) is in a location where it is difficult to work, such as a high place, a low place or a limited space, etc., the taking-out and holding operations of the workpiece can be automated.

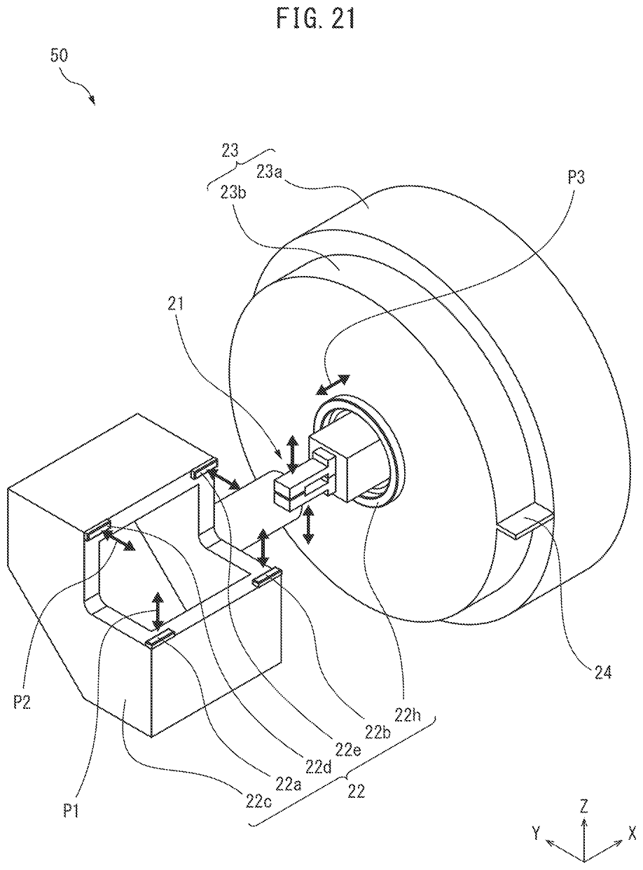

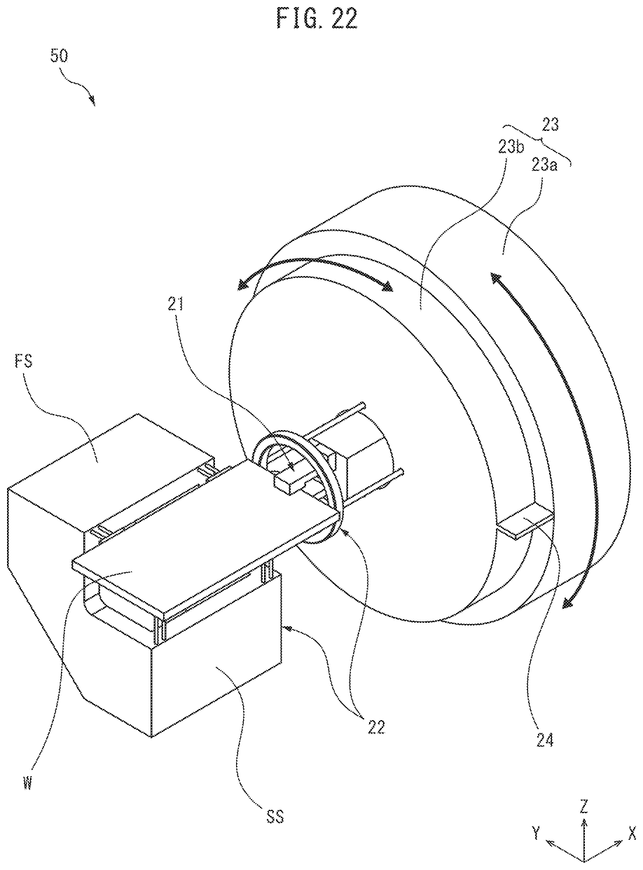

Hereinafter, a hand 50 of a fourth embodiment will be described. FIGS. 21 and 22 are perspective views of a hand 50 of the fourth embodiment. For ease of understanding, only configurations different from the hand 40 of the third embodiment will be described. The hand 50 is a hand configured to take out the workpiece and hold it in three directions. The workpiece holding part 22 holds the workpiece by pressing it in a first direction P1 orthogonal to the axial direction of the hand 50 (the X-axis direction), a second direction P2 orthogonal to the first direction P1, and a third direction P3 (same as the axial direction of the hand 50) orthogonal to both the first direction P1 and the second direction P2. For example, the workpiece holding part 22 includes a plurality of movable members 22a and 22b configured to move forward and backward in the first direction P1, a plurality of movable members 22d and 22e configured to move forward and backward in the second direction P2, and one movable members 22h configured to move forward and backward in the third direction P3. For example, the movable members 22a, 22b, 22d and 22e are rod-shaped bodies, and the movable member 22h is a ring-shaped body. The movable members 22a, 22b, 22d, 22e and 22h are driven by a drive source (not shown) such as a servomotor.

The movable members 22a, 22b, 22d, 22e and 22h are supported by the supporting member 22c, for example. The supporting member 22c is a bracket fixed to the base part 23, for example. The supporting member 22c may have at least one of a first contact surface FS and a second contact surface SS (see FIG. 22) which can contact a predetermined position of the workpiece W to be pressed. By bringing at least one of the first contact surface FS and the second contact surface SS into contact with the predetermined position such as a corner of workpiece W to be pressed, the workpiece can be stably held.

The movable member 22h is a ring-shaped body, for example. The movable member 22h is supported by the base part 23. The movable member 22h is configured to move forward toward the outside of the hand 50 relative to the hand part 21, and move backward toward the inside of the hand 50 relative to the hand part 21. The movable member 22h is positioned around the hand 21, for example. By virtue of this, while the workpiece W is taken out by the hand part 21, the workpiece W can be held by pressing it in the third direction P3, i.e., the depth direction, by the movable member 22h. The movable member 22h is driven by a drive source (not shown) such as a servomotor.

Similarly to the hand 40 of the third embodiment, the base part 23 has the hand rotating part 23a configured to rotate the entirety of the hand 50, and the workpiece holding rotating part 23b configured to rotate only the workpiece holding part 22. The hand part 21 rotates by an arbitrary angle about the axis of the hand 50 (e.g., about the X-axis) according to the motion of the hand rotating part 23a. The hand rotating part 23a and the workpiece holding rotating part 23b are coupled by a gear or a bearing, etc., for example.

The workpiece holding rotating part 23b is configured to rotate on the hand rotating part 23a. The workpiece holding part 22 rotates by an arbitrary angle about the axis of the hand 50 (e.g., about the X-axis) according to the motion of the workpiece holding rotating part 23b. The hand rotating part 23a and the workpiece holding rotating part 23b are driven by a drive source (not shown) such as a servomotor.

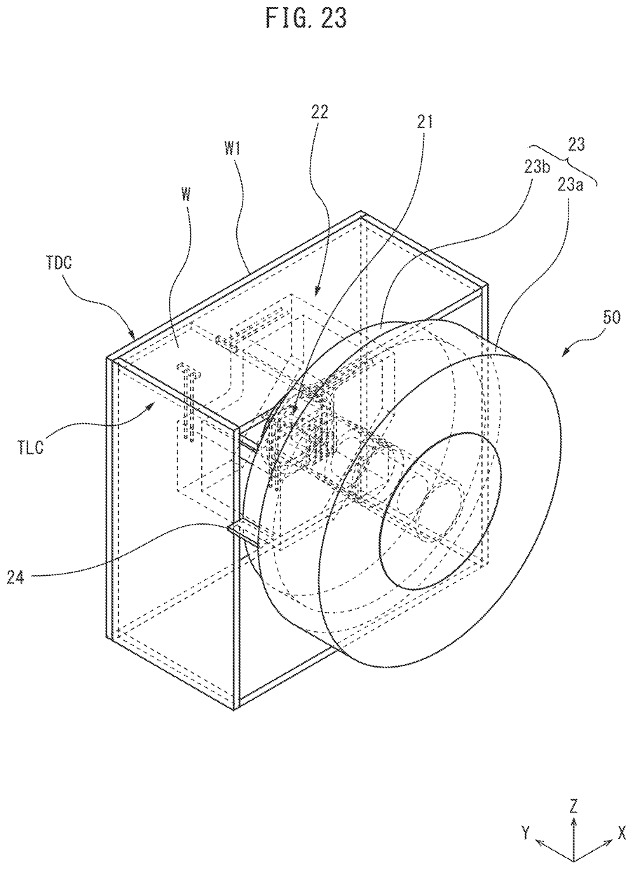

FIGS. 23 to 26 are perspective views showing the hand 50 configured to hold the workpiece W in the three directions (e.g., at two corners). The hand 50 are useful for holding the workpiece by pressing it against two corners of a first workpiece W1 to be processed, which may be a box-shaped body. For example, the hand 50 as shown in FIG. 23 holds the workpiece W by pressing it against a top left corner TLC and a top depth corner TDC of the first work material W1. In other words, the workpiece holding part 22 held the workpiece W by pressing it in the three directions (e.g., X-, Y- and Z-directions). The hand 50 can hold the workpiece W even in the corner in the limited space as such.

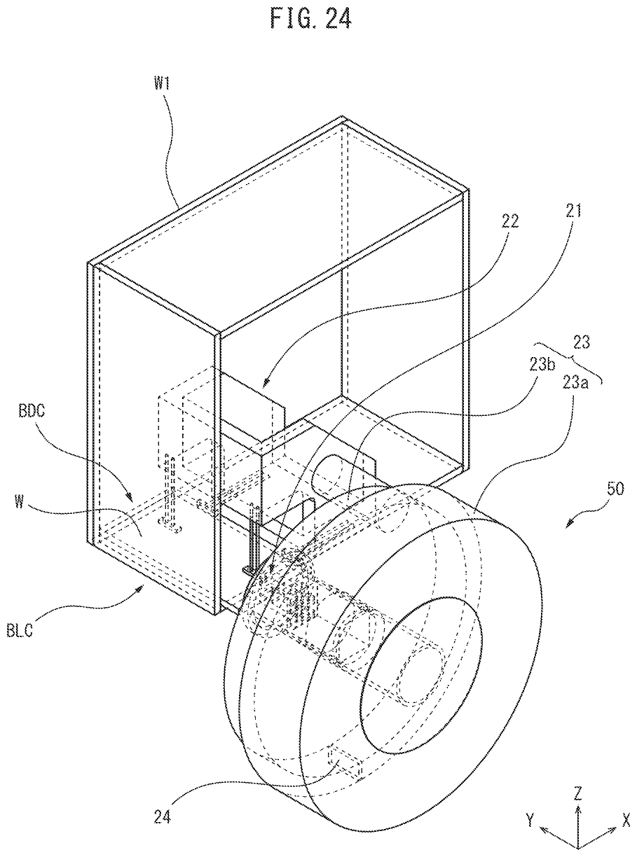

The hand 50 shown in FIG. 24 presses the workpiece W by pressing it against the bottom left corner BLC and the bottom depth corner BDC of the first work material W1. Comparing the hand shown in FIG. 24 and FIG. 23, it can be understood that the hand rotating part 23a does not rotate, and the workpiece holding rotating part 23b rotates by 90° about the axis (e.g., about the X-axis) so as to change only the pressing direction of the workpiece W.

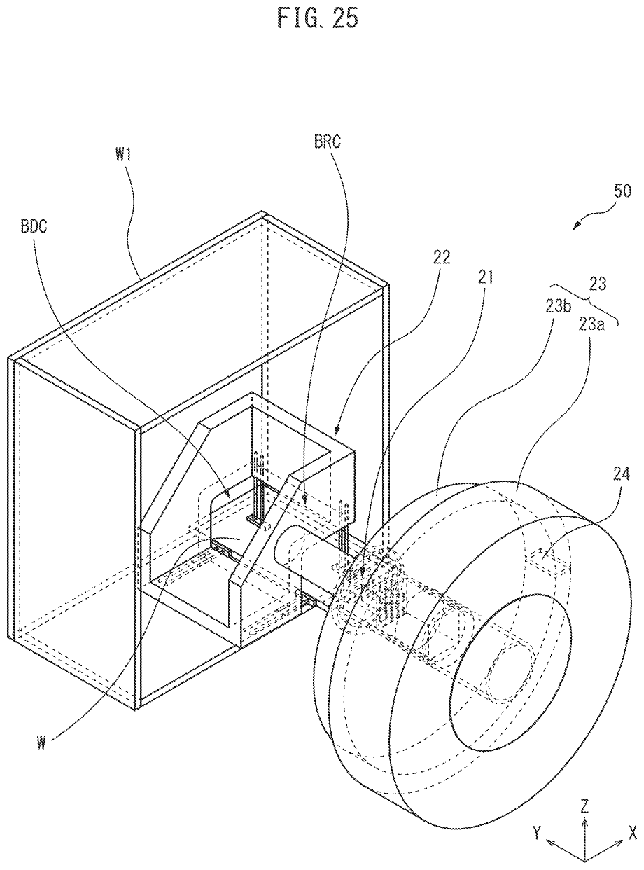

The hand 50 shown in FIG. 25 presses the workpiece W by pressing it against the bottom right corner BRC and the bottom depth corner BDC of the first work material W1. Comparing the hand shown in FIG. 25 and FIG. 24, it can be understood that the hand rotating part 23a does not rotate, and the workpiece holding rotating part 23b rotates by 90° about the axis (e.g., about the X-axis) so as to change only the pressing direction of the workpiece W.

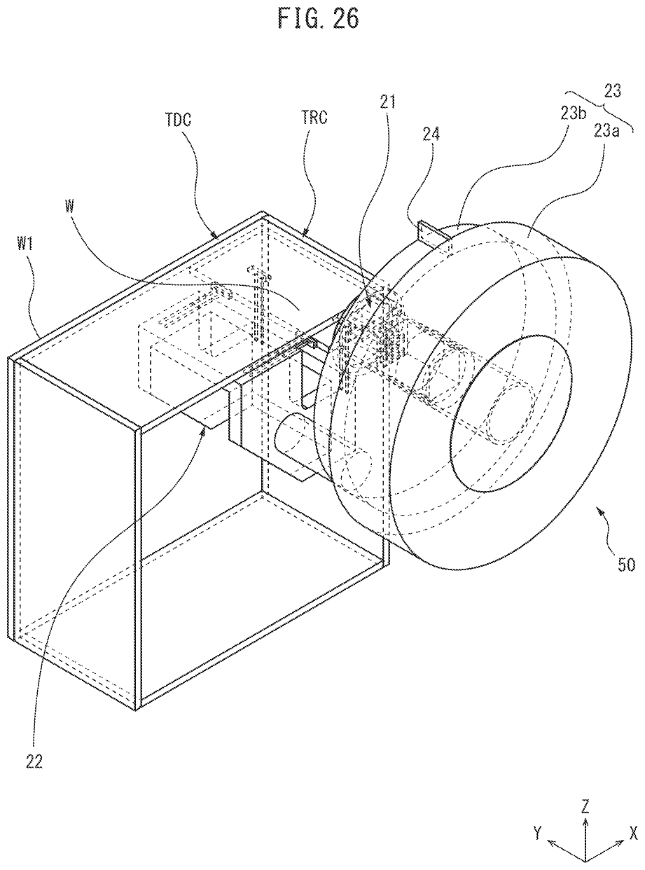

The hand 50 shown in FIG. 26 presses the workpiece W by pressing it against the top right corner TRC and the top depth corner TDC of the first work material W1. Comparing the hand 50 shown in FIG. 26 and FIG. 25, it can be understood that the hand rotating part 23a does not rotate, and the workpiece holding rotating part 23b rotates by 90° about the axis (e.g., about the X-axis) so as to change the pressing direction of the workpiece W.

According to the hand 50 of the fourth embodiment, it is possible to take out the workpiece and hold the workpiece in the three directions. In addition, even if the holding position of the workpiece W (e.g., the two corners) is in a location where it is difficult to work, such as a high place, a low place or a limited space, etc., the taking-out and holding operations of the workpiece can be automated.

It should be noted that the configurations and motions of the hand system and hands in the above embodiments are examples, and that other configurations may be used. For example, the conveying device 10 may be another industrial robot such as a horizontal articulated robot or a parallel link robot, or another form of robot such as a humanoid robot. Also, the conveying device may not be a robot, but another form of conveying devices such as a shuttle or an automated guided vehicle.

The hand portion 21 may be of another type such as a magnetic attraction type, a vacuum attraction type, and a Bernoulli type. Although the workpiece holding part 22 presses and hold the workpiece in one direction, two directions or three directions, it is not necessary that each direction be orthogonal to each other, and thus the workpiece holding part 22 may be configured to hold the workpiece by pressing it in a direction inclined with respect to the axial direction of the hand (e.g., the X-axis direction). Also, the movable members 22a and 22b, the movable members 22d and 22e, and the movable members 22f and 22g, which move forward and backward in the same direction, may be composed of one movable member instead of a plurality of movable members. Further, these movable members may be in other shapes such as plate-like bodies instead of rod-shapes. Still further, the movable member 22h configured to move forward and backward in the depth direction (i.e., the third direction P3) may be of another shape such as an arcuate body instead of a rod-shaped body or a ring-shaped body.

The hand rotating part 23a and the workpiece holding rotating part 23b may be interchanged in their arrangement. In this case, the workpiece holding rotating part 23b rotates the entirety of the hand, and the hand rotating part 23a rotates only the hand part 21. The hand may further has a rotation angle displaying part configured to display the rotation angle of the hand part 21. The rotation angle displaying part configured to display the rotation angle of the hand part 21 may be, for example, a projecting piece projecting from the outer peripheral surface of the hand rotating part 23a.

In addition, it should be noted that the hand 20 can be applied not only to welding, but also to the other jointing such as brazing, fastening, caulking, bonding, snap-fitting, or to taking out and holding a workpiece in the other manufacturing processes. Therefore, the workpiece W may not be a plate-shaped body or rectangular parallelepiped body such as a backing plate or an end tab, but may instead be a workpiece having another shape such as a rod-shape, an H-shape, an L-shape or a T-shape.

The program executed by the above processor and/or another semiconductor integrated circuit, or the program for executing the above flowchart may be recorded and provided on a computer-readable non-transitory recording medium such as a CD-ROM, or may be distributed and provided wired or wirelessly from a server device on a WAN (wide area network) or LAN (local area network).

Although various embodiments are described herein, it should be noted that the present invention is not limited to the above embodiments, and various modifications can be performed within the scope of the claims.

### REFERENCE SIGNS LIST

1 hand system
10 conveying device
30, 40, 50 hand
21 hand part
21a first finger
22b second finger
22 workpiece holding part
22a, 22b, 22d, 22e, 22f, 22g, 22h movable member
22c supporting member
23 base part
23a hand rotating part
23b workpiece holding rotating part
24 rotation angle displaying part
P1 first direction
P2 second direction
P3 third direction
H hand direction
W workpiece
W1 first work material
W2 second work material
W3 third work material
BP butt part
T chamfered portion
FS first contact surface
SS second contact surface
R curved portion
BRC bottom right corner
TRC top right corner
TLC top left corner
BLC bottom left corner
TDC top depth corner
BDC bottom depth corner
S stacker
SE starting edge
EE ending edge
G gap

1. A hand comprising:
a hand part configured to take out a workpiece;
a workpiece holding part configured to hold the taken out workpiece by pressing the workpiece against a predetermined position; and
a base part configured to support the hand part and the workpiece holding part.

2. The hand according to claim 1, wherein the base part has a hand rotating part configured to rotate an entirety of the hand.

3. The hand according to claim 2, wherein the hand part is configured to rotate in units of 180 degrees corresponding to a motion of the hand rotating part.

4. The hand according to claim 1, wherein the base part has a workpiece holding rotating part configured to rotate only the workpiece holding part.

5. The hand according to claim 4, wherein the workpiece holding part is configured to rotate in units of 90 degrees corresponding to a motion of the workpiece holding rotating part.

6. The hand according to claim 4, further comprising a rotation angle displaying part configured to display a rotation angle of the workpiece holding part.

7. The hand according to claim 1, wherein the workpiece holding part is configured to press and hold the workpiece in one direction, two directions, or three directions.

8. The hand according to claim 1, wherein the workpiece holding part has one or a plurality of movable members configured to move forward and backward in a predetermined direction.

9. The hand according to claim 8, wherein the workpiece holding part further has a supporting member configured to support the movable member, and the supporting member has a contact surface capable of contacting the predetermined position against which the workpiece is pressed.

10. A hand system comprising:
a hand configured to take out a workpiece; and
a conveying device, to which the hand is attached, configured to convey the workpiece,
wherein the hand comprises:
a hand part configured to take out a workpiece;
a workpiece holding part configured to hold the taken out workpiece by pressing the workpiece against a predetermined position; and
a base part configured to support the hand part and the workpiece holding part,
and wherein the conveying device is configured to convey the workpiece taken out by the hand part to the vicinity of the predetermined position.

11. A control method of a hand system, the hand system comprising: a hand configured to take out a workpiece; and a conveying device, to which the hand is attached, configured to convey the workpiece, the control method comprising the steps of:
taking out the workpiece by the hand;
conveying the taken out workpiece to the vicinity of a predetermined position by the conveying device; and
holding the taken out workpiece by pressing the workpiece against the predetermined position.
